(19) United States
(12) Patent Application Publication
(10) Pub. No.: US 2003/0084125 A1
(43) Pub. Date: May 1, 2003

(54) Integrated information exchange system for matching shipping demands and carrier availability

(76) Inventors: Paresh L. Nagda, Fremont, CA (US); Julia Z. Li, Fremont, CA (US); Shriniwas D. Wagle, San Jose, CA (US)

Correspondence Address: SKJERVEN MORRILL LLP, 25 METRO DRIVE, SUITE 700, SAN JOSE, CA, 95110, US

(21) Appl. No.: 10/000,121

(22) Filed: Oct. 31, 2001

(51) Int. Cl. G06F 15/16

(52) U.S. Cl. 709/219; 709/218

(57) ABSTRACT

An integrated exchange system for posting and reviewing shipping demand specifications and carrier availability information permits efficient shipper-to-carrier and/or carrier-to-carrier exchanges. The integrated exchange system finds matches between shipping demands and carrier availability and notifies the users of a match. Furthermore, the integrated exchanges system stores the shipping demand specifications and carrier availability information in a database and prepares various reports in response to a user request by using the database.

In one embodiment, the integrated exchange system includes a monitoring unit that monitors the location of carrier vehicles and updates carrier availability information. In this embodiment, a carrier vehicle contains a location determining unit and a wireless modem. Additionally, the integrated exchange system can employ a standardized interface that facilitates data transfers from partner databases.

### BACKGROUND

1. Field of the Invention

This invention relates to communication systems and methods for matching shippers' demands with carriers' capacities.

2. Description of Related Art

A vendors' service is a collective group that creates a list of shipping demands for freight that the vendors in the group want to ship. Carriers that subscribe to the vendors' service review the listed shipping demands and contract to ship the freight. Carriers often need to subscribe to multiple vendors' services to increase their visibility and secure an adequate flow of business. The need to belong to and monitor multiple vendors' service groups results in a complex process of obtaining bookings and wastes the carriers' time. Additionally, the vendors choices for shipping are limited to the subscribing carriers, while other carriers may be able to more effectively ship the goods. More efficient ways are needed to match the shipping demands with the capacities of carriers.

### SUMMARY

In accordance with an aspect of the invention, an integrated exchange allows carriers to fulfill shipping demands and shippers to utilize the capacities of carriers. The exchange provides a single source or gateway for shippers and carriers to post their demands and capacities and review matching results and bids. The system contains a database and a logic unit, and allows integration of content from partner exchanges using published application program interfaces. This gives customers visibility to a large pool for matching demands and capacities.

The integrated exchange can further employ a monitoring system that monitors the locations of carriers' vehicles and matches shipping demands with the location and shipping capacity of the vehicles. Alerts and/or demand information can be sent to vehicles using wireless communication that permits the vehicle's operator to select and fill demands in the database of the exchange.

### BRIEF DESCRIPTION OF THE DRAWINGS

FIG. 1 depicts an integrated exchange system in accordance with an embodiment of the invention.

FIG. 2 depicts components of an integrated exchange server unit in accordance with an embodiment of the invention.

FIG. 3 depicts components of a mobile unit in accordance with an embodiment of the invention.

FIG. 4 is a flow diagram of demand-posting, bid placement, and demand-bid matching processes in accordance with an embodiment of the invention.

FIG. 5A and FIG. 5B depict images a user of an integrated exchange system may see when posting a demand on a web interface, in accordance with an embodiment of the present invention.

FIG. 6 depicts an image a user of an integrated exchange system may see after posting a demand through a web interface, in accordance with an embodiment of the present invention.

FIG. 7 depicts a match report a user of an integrated exchange system may see, in accordance with an embodiment of the present invention.

FIG. 8 is a flow diagram of a demand-checking process in accordance with an embodiment of the present invention.

FIG. 9 depicts a demand report a user of an integrated exchange system may see, in accordance with an embodiment of the present invention.

FIG. 10 depicts an image presenting the details of a bid, in accordance with an embodiment of the present invention.

FIG. 11 depicts an image providing a user of an integrated exchange system with an option to accept a bid, in accordance with an embodiment of the present invention.

FIG. 12 is a flow diagram of a bid-checking process, in accordance with an embodiment of the present invention.

FIG. 13 is a flow diagram of a query process, in accordance with an embodiment of the present invention.

FIG. 14 depicts an image a user may see during the query process of FIG. 13, in accordance with an embodiment of the present invention.

FIG. 15 depicts another image a user may see during the query process of FIG. 13, in accordance with an embodiment of the present invention.

Use of the same reference symbols in different figures indicates similar or identical items.

### DETAILED DESCRIPTION

An integrated exchange system collects and facilitates matching of demands and capacities of shippers, carriers, and participating partner exchanges. A “shipper,” as used herein, refer to a party (e.g., a vendor) that has goods to be shipped. A “carrier,” as used herein, refers to a party having a capacity to transport a shipper's goods. A party may be a shipper in one case and a carrier in another case. A “partner exchange” refers to an entity having a database of shipping demand and/or carrier capacity separate from the database of the integrated exchange system. A partner exchange may use one or more aspects of the present invention to enhance the value of their data or service. Using the integrated exchange system, shippers can post demands for shipping or contact carriers that have posted capacity. A partner exchange can send information to the integrated exchange either in real-time or through asynchronous processing. A partner exchange may include application program interfaces (APIs) developed for integration, which may use standard Internet technologies such as http and XML. A “user,” as used herein, refers to any party who has access to integrated exchange computer 18, including shippers 10, carriers 12, partner exchanges 14, and mobile units 16.

FIG. 1 shows a block diagram of an integrated exchange system 5 in accordance with an embodiment of the invention. Integrated exchange system 5 includes shippers 10, carriers 12, partner exchanges 14, and mobile units 16 that access an integrated exchange computer 18 via a communication network 20. Shippers 10 include shipper 10-1 through shipper 10-m, wherein m is the total number of shippers registered with integrated exchange computer 18. Carriers 12 include carrier 12-1 through carrier 12-n, wherein n is the total number of carriers registered with integrated exchange computer 18. Partner exchanges 14 include partner exchange 14-1 through partner exchange 14-p, wherein p is the total number of partner exchanges registered with integrated exchange computer 18. Mobile units 16 include mobile unit 16-1 through mobile unit 16-q, wherein q is the total number of mobile units registered with integrated exchange computer 18. Shipper 10-i, carrier 12-i, partner exchange 14-i, and mobile unit 16-i each refers to one of shippers 10, carriers 12, partner exchanges 14, and mobile units 16, respectively.

In one embodiment of the present invention, communication network 20 is a global-area computer network used to connect computers regardless of their geographical location, such as the Internet. Shipper 10-i, carrier 12-i, partner exchange 14-i, mobile unit 16-i, and integrated exchange computer 18 may comprise any suitable computers for transferring and processing information through communication network 20, such as personal computers, workstations, and servers. Software programs necessary to provide communications over communication network 20 are executed by shippers 10, carriers 12, partner exchanges 14, mobile units 16, and integrated exchange computer 18. These software programs include operating system programs such as Windows98/NT/2000, MacOS9 or Unix, web browsers such as Internet Explorer or Netscape Navigator, and a variety of application programs (e.g. MS Office).

When shipper 10-i has goods to be shipped, shipper 10-i can access integrated exchange computer 18 and either post a demand on the web site or review carriers' availabilities. A “demand” includes information such as place of origin, destination, trailer type needed, date(s) available, cargo volume and weight, and/or a maximum price that shipper 10-i is willing to pay. In some embodiments, integrated exchange computer 18 automatically books a carrier to fill the demand if a carrier 12 indicates a capacity to fill the demand at less than the shipper's posted maximum fee. In some alternative embodiments, shipper 10-i selects a carrier after reviewing the bids and obtaining additional details, if desired.

Carriers 12 may access the web site for integrated exchange computer 18 to review the posted demands and/or enter bids in response to the posted demands. A “bid” includes information such as place of origin, destination, trailer type available, date(s) available, cargo volume and weight, or an offer price. While a bid may respond to one or more posted demands, it is not necessarily limited to being responsive to a posted demand. For example, carrier 12-i may post an updated capacity and fee as its trucks travel along specified routes and available capacities change. After the bid is posted, the bid may be booked by a shipper looking for a carrier that can provide a service along the route specified in the bid.

In accordance with an aspect of the invention, carriers 12 can limit access to their bid information. Access can be unrestricted (e.g., available to all users), limited to shippers, or limited to a subgroup of shippers or carriers. Additionally, overbooked carriers can post a shipping demand to redirect shipping to another carrier currently having unused capacity. For carrier-to-carrier exchange, the integrated exchange system eliminates the need for an overbooked carrier to telephone several other carriers before finding a carrier able to meet a given demand. The integrated exchange can utilize wireless and Internet technologies to provide a real-time collaboration framework that includes monitoring and contacting vehicles that are in service. This allows each overbooked carrier 12-i to limit their overflow work to members of a preferred subgroup, for example, to specific carriers having an alliance with the overbooked carrier 12-i.

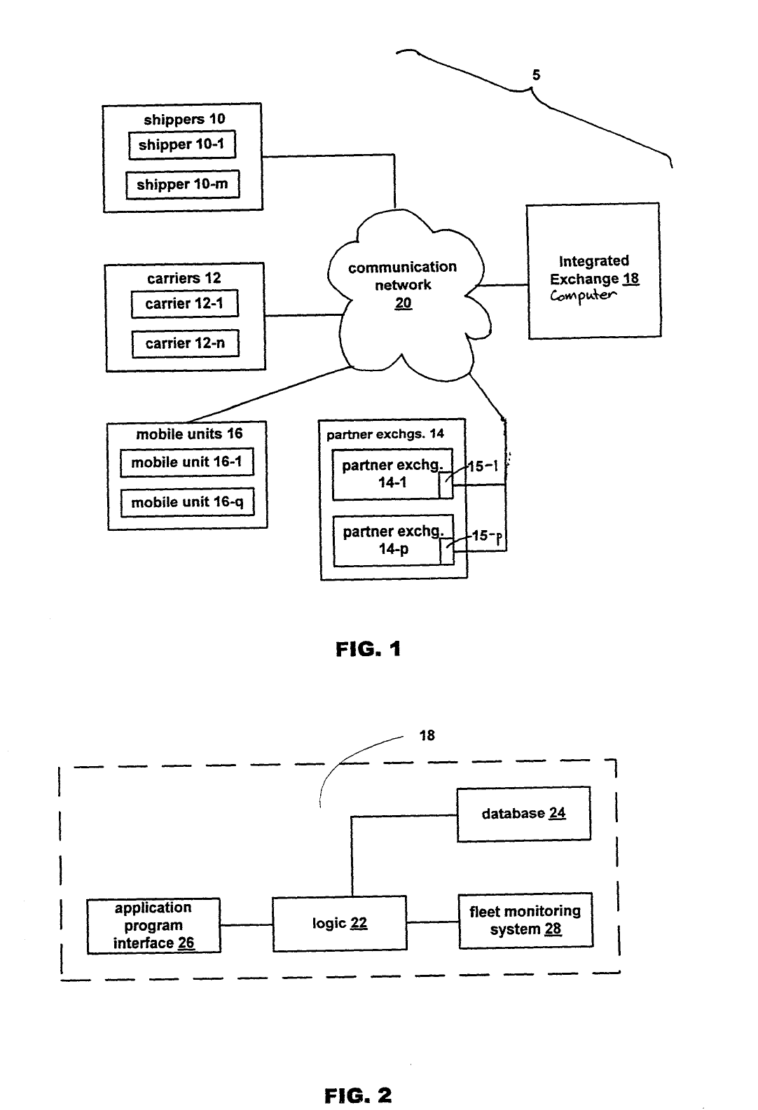

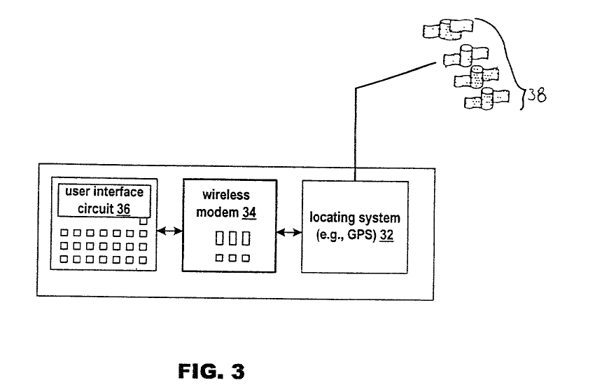

Each of partner exchanges 14 can be a web service provider or any other party that maintains a database of shipping demands and/or carrier capacity. Each partner exchange 14-i uses an application program interface (API) 15 that communicates with API 26 (FIG. 2) of integrated exchange computer 18. In one embodiment, APIs 15 and 26 can operate in real time, so that the information in integrated exchange computer 18 is updated to match the database in partner exchange 14 immediately or shortly after the database in partner exchange 14 receives new information. In alternative embodiments, APIs 15 and 26 operate through asynchronous processing depending on the needs of the customer. When APIs are operating in asynchronous processing, the data in integrated exchange computer 18 may be updated at a predetermined time interval, e.g., every 20 minutes. The demand and capacity data transferred to integrated exchange computer 18 from partner exchanges 14 provide shippers 10 and carriers 12 with more content to improve efficiency in the arrangement of shipping.

Mobile units 16 may be transportation units (e.g., delivery trucks) employed by carriers 12. Mobile unit 16-i may be able to access computer network 20, for example through a wireless communication network. Details on mobile unit 16-i are provided in reference to FIG. 3.

FIG. 2 depicts some components of integrated exchange computer 18 in accordance with one embodiment of the present invention. Components of an exemplary embodiment of integrated exchange computer 18 include a logic unit 22, a database 24, an application program interface (API) 26, and a fleet monitoring system 28. Logic unit 22 implements the presentations and functions of the web interface that shippers 10 and carriers 12 use. Database 24 holds the posted demands and capacities for shipping. API 26 is a software implementing Internet communications and data transfers between integrated exchange computer 18 and APIs 15 of one or more partner exchanges 14. Fleet monitoring system 28 may record and provide information regarding the locations of vehicles in a carrier's fleet. In some embodiments, integrated exchange computer 18 interfaces users through a web site (not shown) implemented using a standard web server. Techniques for creating a web site are well known.

FIG. 3 depicts components of a mobile unit 16-i in accordance with one embodiment of the present invention. In accordance with one aspect of the invention, carriers 12 employ mobile stations 16 (e.g., in delivery trucks) that wirelessly communicate with integrated exchange computer 18. Mobile unit 16-i includes a locating system 32, a wireless modem 34, and a user interface circuit 36. Locating system 32 determines the location of mobile unit 16-i. In an exemplary embodiment of the invention, locating system 32 is a commercially available global positioning satellite (GPS) system that uses signals from a satellite network 38 to determine the location of mobile unit 16-i. Alternatively, other locating systems such as systems triangulation based on ground based landmarks can be employed. Wireless modem 34 conducts communications via a wireless network service between mobile units 16 and communication network 20, which allows access to integrated exchange computer 18. Further details on the use of fleet monitoring system 28 to track the location of mobile unit 16 are provided in U.S. Pat. No. 5,959,577 to Rodric C. Fan et al titled “Method and Structure for Distribution of Travel Information Using Network,” which is herein incorporated by reference in its entirety.

In accordance with one aspect of the invention, a user of mobile unit 16-i (e.g., a delivery truck driver) can access integrated exchange computer 18. For example, the user can activate mobile unit 16-i via interface circuit 36 to review demands for shipments. Locating system 32 then determines the position of mobile unit 16-i and forwards position data through wireless modem 34 to integrated exchange computer 18. Fleet monitoring system 28 records the position data and permits carrier 12-i at their headquarters or elsewhere to access the location data. Logic unit 22 receives a request for a demand from mobile unit 16-i and selects appropriate demands based on the location of the mobile station 16-i and a criterion established by carrier 12-i or mobile station 16-i. The criterion maybe, for example, a pick-up point within a 10 mile-radius of mobile unit 16-i, a particular size and weight of the freight, a price and/or a destination. Integrated exchange computer 18 sends the selected demands to mobile unit 16-i, which may include a computer display unit. The user of mobile unit 16-i can then confirm the booking of one or more of the demands by using the computer display unit.

To facilitate automatic tracking of the fleet, control circuit 36 can automatically contact integrated exchange computer 18 and periodically transfer GPS location data to fleet monitoring system 28. Logic unit 22 can then respond to the automatic accesses in the same manner as if the user of mobile unit 16-i accessed integrated exchange computer 18. Automatic tracking of mobile units 16 also allows shippers to track their shipments by using network communication 20.

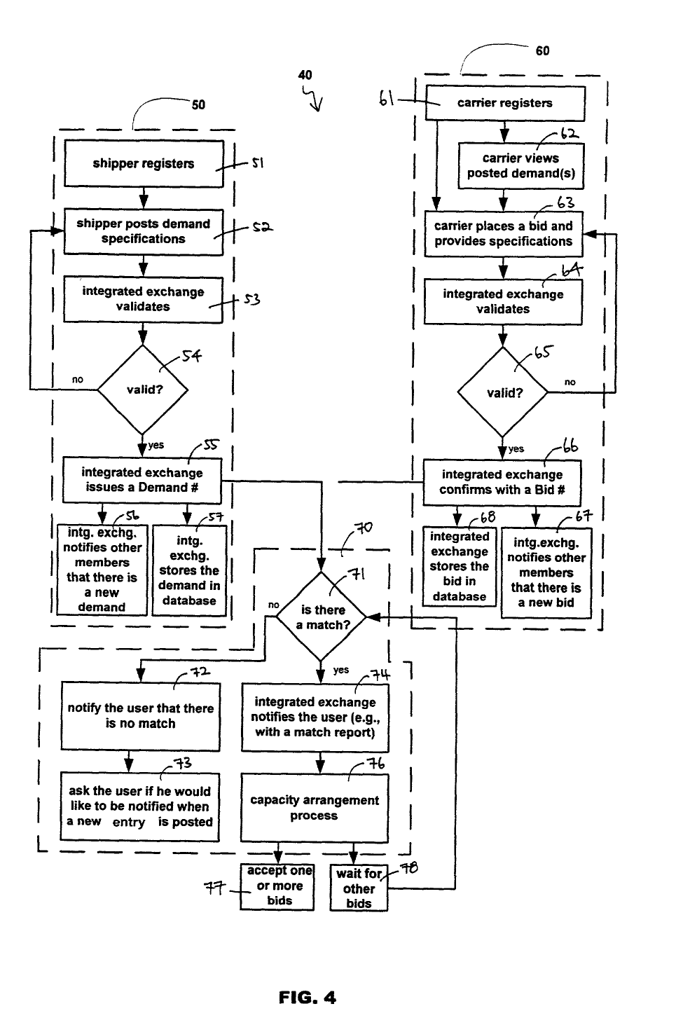

FIG. 4 shows a flowchart of an integrated exchange process 40 in accordance with an embodiment of the present invention. Integrated exchange process 40 includes demand-posting process 50, bid placement process 60, and matching process 70.

Demand-posting process 50 may typically be used by shippers 10 or overbooked carriers. Demand-posting process 50 begins with registration, as shown in stage 51 whereby a user registers to become a member of integrated exchange computer 18. The registration process may include any well-known method of registration, and may include identity verification and credit checks. If the user successfully registers with integrated exchange computer 18, the user receives a login name that it can use to access integrated exchange computer 18. In stage 52, the user accesses integrated exchange computer 18 and posts one or more demand entries. A demand entry includes specification such as a date the carrier service is desired, a trailer type, a point of origin, and a destination. In stage 53, integrated exchange computer 18 validates the demand entry. Validation may entail, for example, checking that all required parameters are provided and verifying that the date is not outside a predetermined range into the future. If any parameter is unacceptable, integrated exchange computer 18 takes the user back to stage 52 and requests that the erroneous entry be corrected, as shown in stage 54. After a demand entry is validated, integrated exchange computer 18 confirms the entry by issuing a Demand number (stage 55). Then, integrated exchange computer 18 notifies users of integrated exchange computer 18 that a new demand entry has been posted (stage 56). In addition, integrated exchange computer 18 stores the new demand entry in database 24 (stage 57).

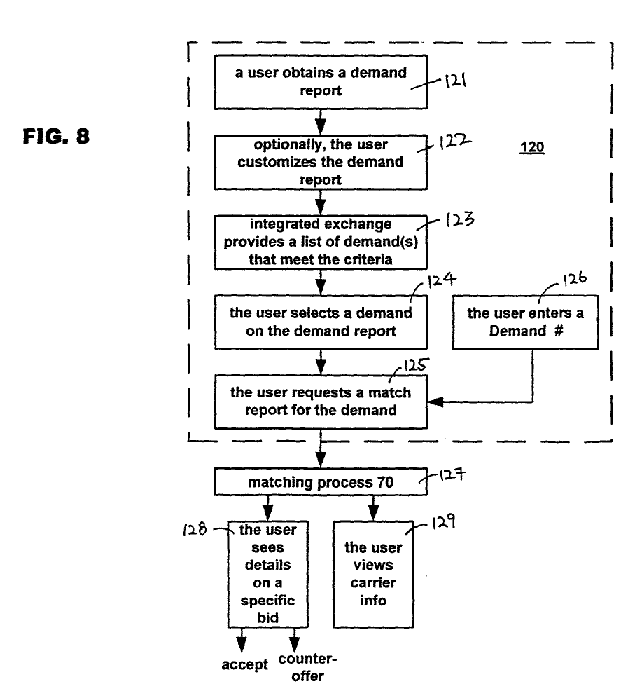

In bid placement process 60, a user (e.g., carrier 12-i) accesses the web site for integrated exchange computer 18 and submits a bid. A bid is herein also referred to as “carrier entry.” A bid may be placed in response to a specific demand entry, or may be placed to inform other parties of an availability. Bid placement process 60 includes registration process (stage 61) whereby a user registers with integrated exchange computer 18 and a login name is issued. Using the login name, the user may view the posted demands (stage 62), for example by using demand-checking process 120 depicted in FIG. 8 or query process 170 depicted in FIG. 13. The user places a bid (stage 63) and provides details about availability. In stage 64, logic unit 22 validates the information entered in stage 62. If any of the specifications are incomplete or unacceptable, logic unit 22 takes the user back to stage 63 and requests that the user correct the error (stage 65). Once all the provided information is validated, logic unit 22 issues a Bid number (stage 66) and notifies the users that a new bid has been entered (stage 67). Logic unit 22 also stores the new bid in database 24 (stage 68) so that the bid details can be retrieved later (e.g., during matching process 70).

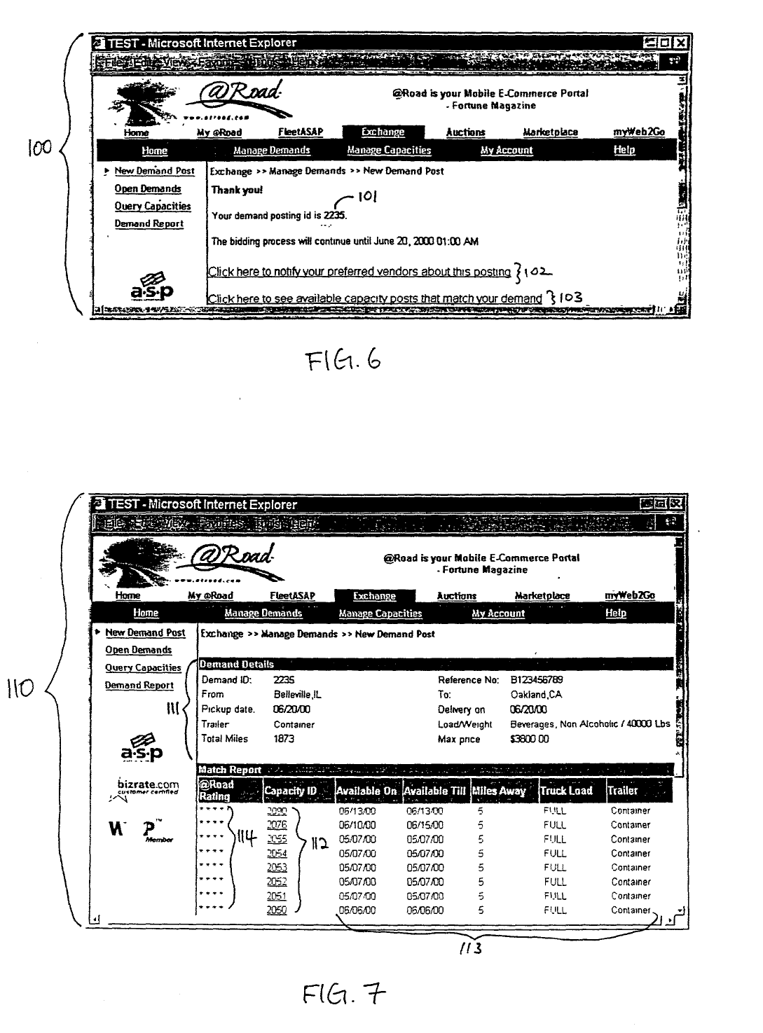

Matching process 70 may be triggered by demand-posting process 50 and/or bid placement process 60, or may be executed regularly at a predetermined time interval. Upon detecting a new demand, new logic 22 searches dabatase 24 for bids that match the specifications of a demand (stage 71). Likewise, upon detecting a new bid, logic unit 22 sends database 24 for demands having parameters that match the new bid (stage 71). If there is no match, logic unit 22 notifies the user who made the latest entry that there is no match (stage 72). Optionally, logic unit 22 may inquire a user who posted a demand whether it would like to be notified when a new bid is posted or inquire a user who placed a bid whether it would like to be notified when a new demand is posted (stage 73). If one or more matches are found in stage 71, the user is notified of the match(es), for example by being presented with a match report that lists demands with matching specifications (stage 74). In some embodiments, the bids on the match report may be ranked based on how closely they match, price, or distance between the originating point and the location of carrier vehicle. FIG. 7 shows an exemplary match report in the format that may be preferred when matching process 70 is triggered by a newly-posted demand.

Matching process 70 includes capacity arrangement process 76. During capacity arrangement process 76, users arrange details concerning capacity. Capacity arrangement process 76 may entail shipper-to-carrier communication, carrier-to-mobile unit communication, and/or carrier-to-carrier communication. Capacity arrangement process 76 is especially useful when a shipper's “needed capacity” specification and a carrier's “available capacity” specification do not match perfectly. If a carrier's available capacity is less than the shipper's need, multiple carriers may be needed. On the other hand, if a carrier's capacity exceeds the shipper's need, the carrier may make arrangement with other shippers by using demand-posting process 50 in order to fill the excess capacity. In some embodiments, capacity arrangement process 76 entails posting a demand or capacity specification and notifying other users of the new posting almost immediately. Additionally or alternatively, capacity arrangement process 76 includes sending an electronic mail, paging, or calling one or more users regarding the demand or capacity specification. As described below in reference to FIG. 13, capacity arrangement process 76 may be integrated with a query process to allow mobile units on the road to efficiently react to changes in delivery schedules or loads.

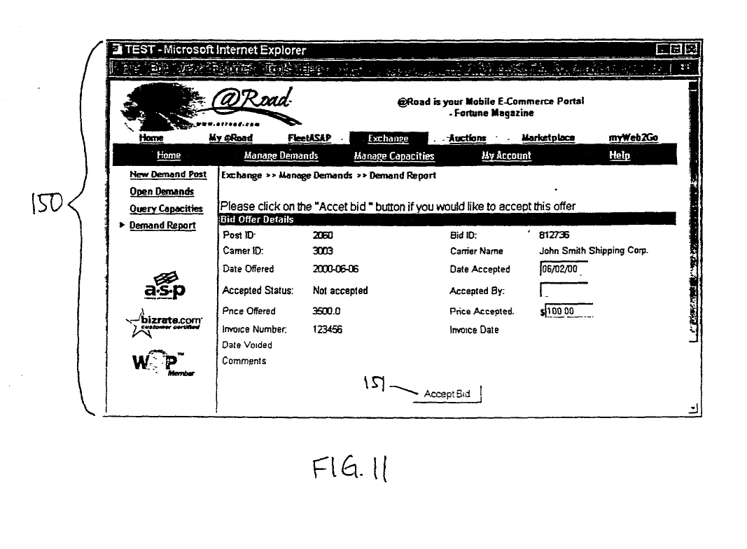

After one or more of the communication sessions, a user may accept a bid (stage 77), make a counter-offer (not shown), or wait for more demands or bids to be entered (stage 78). A user may accept a bid or book a shipment demand through integrated exchange computer 18. Any of the well-known methods for conducting secure transactions over a communication network may be used in completing a transaction using integrated exchange computer 18. FIG. 11 provides an example of an image a user may see before accepting a bid. A person of ordinary skill in the art realizes that there are numerous algorithms for determining demand-bid matches based on a set of parameters.

For example, shipper 10-i seeking to transport 1000 lbs. of goods from point A to point C may see on the match report that carrier 12-i placed a reasonably priced bid for shipment from point A to point B, which lies between point A and point C. Shipper 10-i contacts carrier 12-i to check the capacity of carrier 12-i and finds out that carrier 12-i can only transport 700 lbs. of goods. Shipper 10 may now use demand-posting process 50 to post a new demand for shipment of 300 lbs. of goods from point A to point B, shipment of 300 lbs. of goods from point A to point C, and shipment of 700 lbs. of goods from point B to point C, and wait for bids. After bids are entered, shipper 10-i selects one or more shipments based on criteria that are important to shipper 10-i, for example economic efficiency or speed.

In this example, if carrier 12-i wishes to avoid the risk of losing its opportunity to book the shipment of 700 lbs. of goods from point A to point B, carrier 12-i may post a first demand with parameters including transport 300 lbs. of goods from point A to point B and a second demand including 1000 lbs. of goods from point B to point C. In addition, carrier 12-i may check the location of its trucks using fleet monitoring system 28 and contact trucks that appear to be traveling along the same route. Trucks traveling along the same route may be able to consolidate their cargo, thereby freeing up a truck (perhaps a truck with 1000 lbs. capacity) to fulfill the need of shipper 10-i.

In some embodiments, shipper 10-i provides a maximum price it is willing to pay as part of demand specifications in stage 52. Integrated exchange computer 18 automatically searches database 22 for a bid that meets all the requirements of shipper 10 including the maximum price.

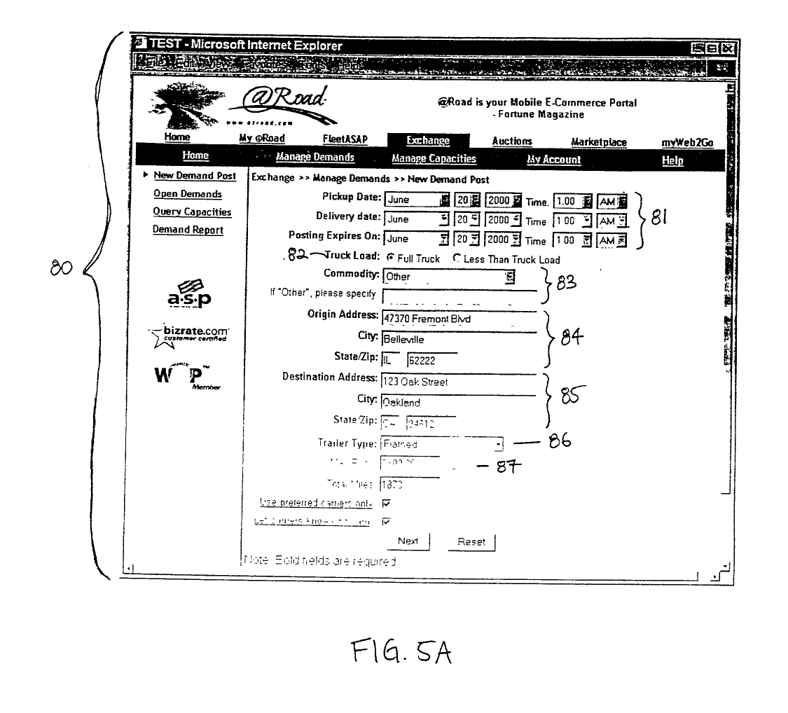

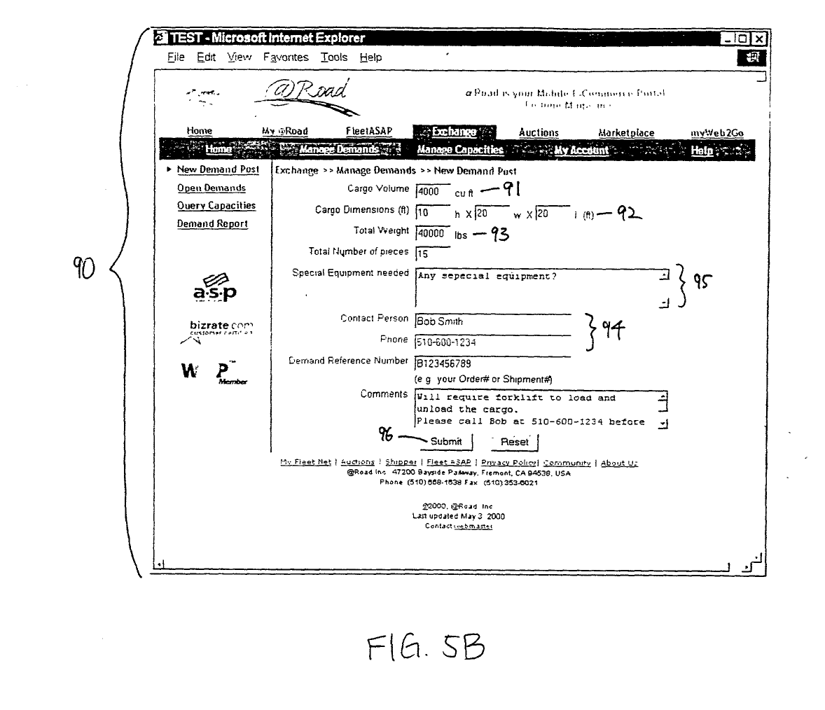

FIG. 5A and FIG. 5B depict exemplary images 80 and 90 a user may see while posting a demand in stage 52. In the particular embodiment, a user posting a demand is required to provide dates 81, truck load 82, type of commodity 83, place of origin 84, destination 85, trailer type 86, maximum price 87, as well as cargo volume 91, cargo dimensions 92, and total weight 93. In addition, a contact person may be identified along with relevant contact information 94. Also, the user is asked to list the type of special equipment needed (stage 95), if any. After filling in all the information, the user clicks on the “submit” icon 96 to proceed to stage 53.

FIG. 6 depicts an image 100 a user may see in stage 55. After validating the demand specification information, integrated exchange computer 18 returns a Demand number 101. In the embodiment that is depicted, integrated exchange computer 18 provides the user with an option 102 to notify a preferred group of carriers about this posting. In addition, integrated exchange computer 18 provides the user with an option 103 to skip to stage 76 and begin deciding capacity details.

FIG. 7 depicts an image 110 a user may see in stage 74 of matching process 70. Image 110 depicts a match report pertaining to a specific demand, the details of which are shown in panel 111. The Match report provides a list of capacity IDs (which may be equivalent to Bid IDs in some embodiments) 112, some basic information 113 about each capacity ID on the list, and a rating 114 based on a predetermined set of criteria. The particular embodiment provides hyperlinks so that the user can click on a capacity ID 112 and see more details about the selected bid.

FIG. 8 depicts a flowchart of a demand-checking process 120 in accordance with one embodiment of the present invention. After logging on to the website for integrated exchange computer 18, a user accesses a demand report (stage 121). An unrestricted demand report lists all the “open” or unfulfilled demands that are posted. A user may view a complete, unrestricted demand report or customize the demand report. For example, in stage 122, the user customizes a demand report by restricting it to, for example, a preferred group of shippers, a preferred group of carriers, or carriers located within a limited radius away from the point of origin. Integrated exchange computer 18 searches database 24 and presents the user with a demand report listing the demands that meet the criteria (stage 123). The user may select a demand from the demand report (stage 124) and request a match report for the chosen demand (stage 125). The user may also obtain details on a particular demand by providing the Demand number (stage 126) instead of selecting a demand from the demand report (as in stage 124). Once a match report is requested, the user is taken through matching process 70 (stage 127) described above, in reference to FIG. 4. Alternatively, the user may request to see details on a specific bid (stage 128) or view information about certain carriers or other shippers (stage 129). After reviewing the necessary bid details, the user may accept a bid or make a counter-offer, or wait for more bids.

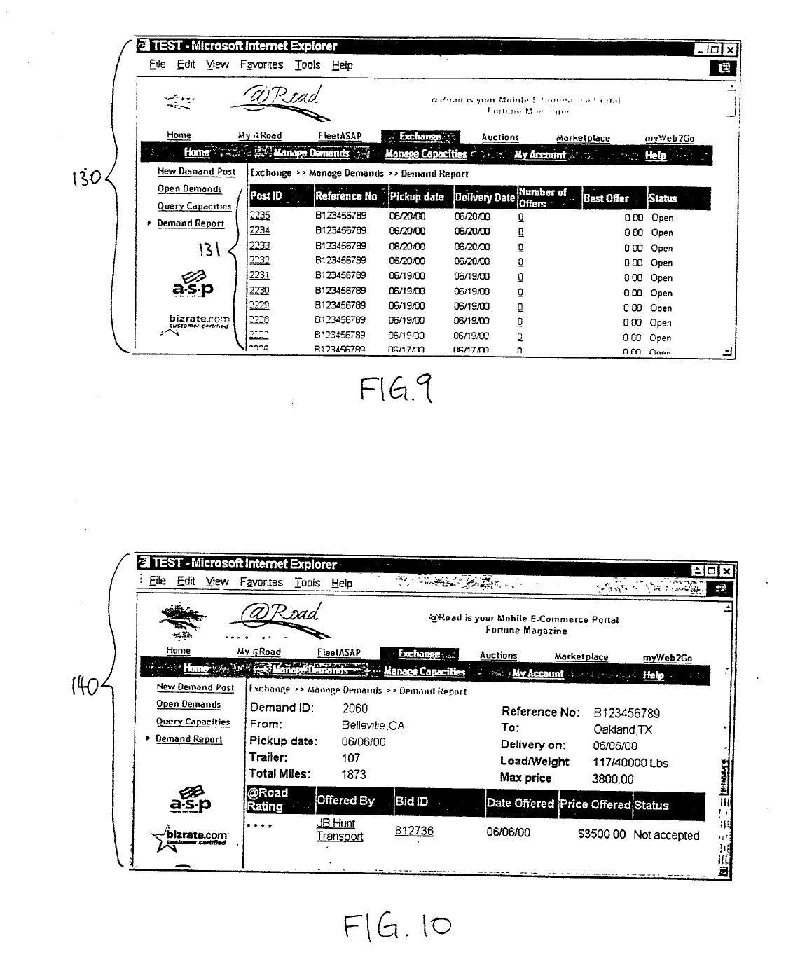

FIG. 9 provides an image 130 of a demand report a user of demand-checking process 120 may see in stage 124. As shown in panel 131, a demand report of the depicted embodiment lists Bid ID #s (which are shown as Post ID#s) and some basic details about each bid that is listed. FIG. 10 and FIG. 11 depict images 140 and 150, respectively. Images 140 and 150 may be presented to a user in response to the user's clicking on one of the hyperlinked Bid ID#s in FIG. 9 and proceeding to stage 128. Images 140 and 150 both present the user with more details on the selected bid than image 130. After reviewing the bid details provided, a user may click on the “Accepted” icon 151 to complete a transaction.

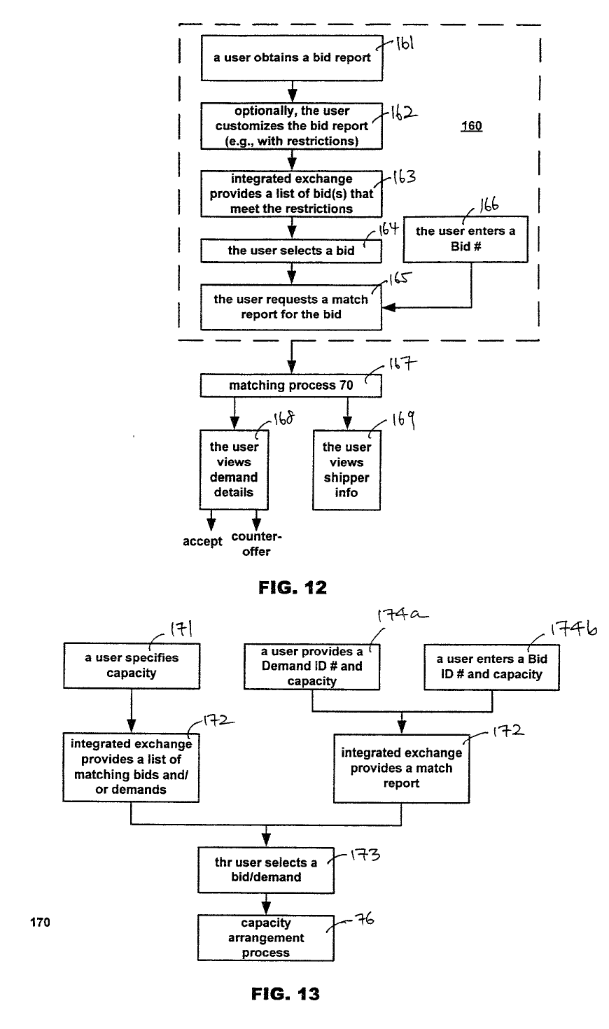

FIG. 12 depicts a flowchart of a bid-checking process 160 in accordance with one embodiment of the present invention. Bid-checking process 160 is similar to demand-checking process 120. A user logs onto the website for integrated exchange computer 18 and accesses a bid report (stage 161). A complete bid report lists all the bids that are placed. In stage 162, the user may, optionally, customize the complete bid report by placing restrictions such as a minimum price or a preferred group of vendors. In response, integrated exchange computer 18 presents to the user a list of bids in database 24 that meets the restrictions (stage 163). From the list, the user may select a bid (stage 164) and request a match report for the selected bid (stage 165). In addition or alternatively, the user may provide a Bid number, as shown in stage 166, and request a match report for the identified bid (stage 165). The request for a match report triggers matching process 70 (stage 167). If matching process 70 results in finding a match, the user is then presented with an option 168 to view details on the matching demands, so he can select a demand and book a shipment to fulfill a demand. In addition, the user is presented with option 169 to view more details about the shipper associated with each demand.

FIG. 13 depicts a flowchart of a query process 170, which may be integrated with capacity arrangement process 76 or be an independent process. Using query process 170, a user can provide criteria (e.g., capacity needed and a radius) and request a search of database 24 for entries that match the specifications (stage 171). For example, a user may query to see if there is a carrier available to transport 500 lbs. of goods from point A to point C by October 19. Integrated exchange computer 18 searches database 24 and responds to the query with a match report based on capacity (stage 172). After reviewing the match report, the user may select a Bid number or a Demand number that are on the match report (stage 173) and proceed to capacity arrangement process 76. If the user knows the demand number or the bid number of the entry he is interested in finding a match for, the user may enter the Demand number or the Bid number to obtain a match report of all capacities that match the identified demand (stages 174a and 174b). Logic unit 22 of integrated exchange computer 18 searches database 24 to find matching entries and provides the user with a match report (stage 172). From the match report, the user can select a matching bid or a matching demand in stage 173, and eventually proceed to capacity arrangement process 76.

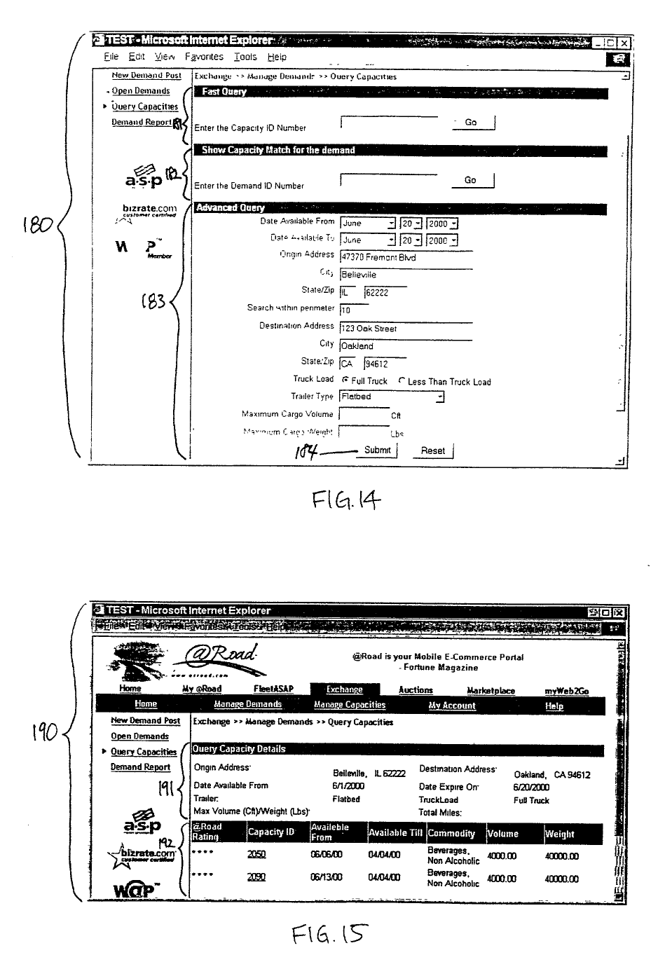

FIG. 14 depicts an image 180 a user may see upon starting query process 170. Panel 181 allows the user to enter a Bid number, panel 182 allows the user to enter a Demand number, and Panel 183 allows the user to enter the details of his/her query. After responding to the requests in one of the panes, the user may click on the “Submit” icon 184 to trigger stage 172. Eventually, the user sees an image containing responsive information, such as image 190 in FIG. 15. FIG. 15 provides query details 191 and a list of matching entries 192.

An additional feature to the invention includes a Business Report compilation function. Logic unit 22 may store every demand and every bid that is entered into integrated exchange computer 18, either in database 24 or a separate database (not shown). Logic unit 22 stores not only the specifications of each demand and bid, but also whether the demand or the bid successfully completed a transaction using integrated exchange system 5, the length of time from the entry of the demand/bid to completion of the transaction, and which shipper/carrier fulfilled the demand/bid. Thus, integrated exchange system 5 is a useful business analysis tool for its users.

Furthermore, integrated exchange system 5 can be integrated with an Enterprise Resource Planning (ERP) system (e.g., SAP), so that demands are posted automatically if the system shows that certain products are needed and shipments can be automatically booked. For example, if a cleaning solution manufacturing company integrates integrated exchange system 5 with its ERP, orders for the required amount and type of chemicals may be entered into the ERP and delivery may be automatically scheduled with integrated exchange system 5. The automated system may improve the efficiency and the accuracy of a company.

Although the invention has been described with reference to particular embodiments, the description is only an example of the invention's application and should not be taken as a limitation. In particular, even though much of preceding discussion was aimed at systems using the Internet and World Wide Web, alternative embodiments of this invention could employ other data communication systems that exist or may be developed. Further, although the invention is described in relation to the shipment of freight, other embodiments or the invention can be employed in other fields such as but not limited to the dispatching of taxis or other transportation vehicles. Various other adaptations and combinations of features of the embodiments disclosed are within the scope of the invention as defined by the following claims.

I claim:

1. An information exchange system comprising:
a database coupled to a communication network, said database storing a demand entry comprising shipping demand specifications and a carrier entry comprising carrier availability information, wherein said demand entry and said carrier entry arrive through said communication network; and
a logic unit coupled to said database, said logic unit receiving a user request and at least one of said demand entry and said carrier entry through said communication network and formulating a response to said user request.

2. The information exchange system of claim 1, further comprising a link to a partner system comprising a partner database, wherein said partner database contains entries comprising at least one of demand specifications and carrier availability information.

3. The information exchange system of claim 1, wherein said logic unit notifies a user when one of a demand entry and a carrier entry is received.

4. The information exchange system of claim 1, further comprising an Enterprise Resource Planning system that forwards shipping demand specifications and carrier availability information to said database.

5. The information exchange system of claim 1, wherein said logic allows a user to define a subgroup within said exchange system and limit unrestricted access of at least a portion of said database only to members of said subgroup.

6. The information exchange system of claim 1, wherein said user request comprises a request for a demand report containing at least a portion of shipping demand specifications.

7. The information exchange system of claim 6, wherein said user request further comprises a criterion said logic unit uses to decide entries to include in said demand report.

8. The information exchange system of claim 6, wherein said communication network is the Internet and said demand report comprises hyperlinks to other reports containing at least one of a shipping demand specification and carrier availability information.

9. The information exchange system of claim 1, wherein said user request comprises a carrier availability report containing at least one entry comprising carrier availability information stored in said database.

10. The information exchange system of claim 9, wherein said user request further comprises a criterion said logic unit uses to decide entries to include in said carrier availability report.

11. The information exchange system of claim 9, wherein communication network is the Internet and said carrier availability report comprises hyperlinks to other reports containing details of carrier availability information.

12. The information exchange system of claim 1, wherein said shipping demand specification comprises at least one of a route, a point of origin, a destination, a vehicle type, date(s) of availability, cargo dimensions, cargo weight, cargo content, and an offer price.

13. The information exchange system of claim 1, wherein said carrier availability information comprises at least one of carrier mobile unit routes, point of origin, destination, vehicle type, date(s) of availability, cargo dimensions, cargo weight, cargo content, and a price.

14. The information exchange system of claim 1, wherein said logic unit alerts a user when one or more parameters of a shipping demand entry match one or more parameters of a carrier availability entry.

15. The information exchange system of claim 14, wherein said logic unit provides a user with an option to make capacity-based arrangements.

16. The information exchange system of claim 14, wherein said logic unit provides a user with an option to conduct a transaction over said communication network.

17. The information exchange system of claim 1, wherein said user request identifies at least one demand entry, and wherein said report is a match report listing carrier entries having parameters that at least partially match the parameters of the identified demand entry.

18. The information exchange system of claim 1, wherein said user request identifies at least one carrier availability entry and said report is a match report listing shipping demand entries having parameters that at least partially match the parameters of the identified carrier availability entry.

19. The information exchange system of claim 1, wherein said user request comprises one of an implied request and an express request for said logic unit to store received information in said database.

20. The information exchange system of claim 1, further comprising a fleet monitoring system that monitors locations of delivery vehicles.

21. The information exchange system of claim 20, wherein said logic unit alerts a delivery vehicle when a new demand entry matches a location of said delivery vehicle as determined by said fleet monitoring system.

22. The information exchange system of claim 20, wherein each of said delivery vehicles contains a GPS unit and a wireless modem that transmits location data for each of said delivery vehicles to said fleet monitoring system.

23. The information exchange system of claim 22, wherein said wireless modem provides an Internet connection to the fleet monitoring system.

24. The information exchange system of claim 20, wherein at least one of said delivery vehicles contains a portal allowing a driver to see demands from the database.

25. The information exchange system of claim 20, wherein a GPS unit and a wireless modem in one of said delivery vehicles automatically transmit location data for said delivery vehicle to the fleet monitoring system, and the logic uses the location data in determining whether to send an alert to the delivery vehicle.

26. The information exchange system of claim 1, wherein said logic unit formulates said response when a new entry is received.

27. The information exchange system of claim 1, wherein said logic unit formulates said response at a predetermined time interval.

28. The information exchange system of claim 1, wherein said response is a business analysis report comprising at least one of said demand entries and said carrier entries entered into said database during a selected date range and details of transactions relating to said entries.

29. The information exchange system of claim 1, wherein said shipping demand specification comprises an offer price and said carrier availability information comprises a bid price, and wherein said logic unit arranges a transaction between a shipper and a carrier based on the difference between said offer price and said bid price.

30. A method comprising:
receiving a request from a user;
receiving at least one of a demand entry and a carrier entry from said user, said demand entry comprising shipping demand specifications and said carrier entry comprising carrier availability information;
storing said entry in a database; and
using said entries to formulate a response to said request.

31. The method of claim 30, further comprising accessing a partner database and transferring data from said partner database to said database.

32. The method of claim 31, wherein said data comprises at least one of shipping demand specification and carrier availability information.

33. The method of claim 30, wherein said database receives at least one of a request and an entry from Enterprise Resource Planning system.

34. The method of claim 30, further comprising allowing a user to define a subgroup of shippers and carriers and granting unrestricted access to said database only to said subgroup.

35. The method of claim 30, further comprising comparing parameters of said demand entry and parameters of said carrier entry and notifying said user if parameters of said demand entry at least partially match the parameters of said carrier entry.

36. The method of claim 35, wherein said demand entry comprises an offer price and said carrier entry comprises a bid price, further comprising executing a transaction over a communication network between a first user who entered said offer price and a second user who entered said bid price.

37. The method of claim 35, further comprising providing a user with at least one of matching demand specifications and matching availability information.

38. The method of claim 30, wherein said request comprises at least one criterion and wherein said response comprises at least one entry that meets said criterion.

39. The method of claim 30, wherein said entry comprises at least one of a route, a point of origin, a destination, a vehicle type, date(s) of availability, cargo dimensions, cargo weight, cargo content, and a price.

40. The method of claim 30, further comprising monitoring locations of delivery vehicles.

41. The method of claim 39, further comprising alerting a delivery vehicle when the location of said delivery vehicle matches a parameter of a demand entry.

42. The method of claim 39, wherein said delivery vehicle comprises a location determining unit and a wireless connected to a communication network.
